(19) United States
(12) Patent Application Publication
(10) Pub. No.: US 2025/0220790 A1
(43) Pub. Date: Jul. 3, 2025

(54) ADVANCED LED LIGHTING SYSTEM WITH ADAPTIVE WAVELENGTH CONTROL AND NETWORK INTEGRATION

(71) Applicant: CROSSROADS LED, Owasso, OK (US)

(72) Inventor: Buddy A. Stefanoff, Owasso, OK (US)

(21) Appl. No.: 18/399,953

(22) Filed: Dec. 29, 2023

(51) Int. Cl. H05B 45/22; H05B 45/28

(52) U.S. Cl. CPC H05B 45/22; H05B 45/28

(57) ABSTRACT

Advanced led lighting system with adaptive wavelength control and network integration is disclosed herein. An example method includes emitting light from an LED at a specific wavelength, primarily focusing on amber LED light; detecting the emitted light wavelength using a photodetector; analyzing the detected wavelength for deviations from a target wavelength of approximately 592 nanometers; and adjusting the current and voltage supplied to the LED based on the detected wavelength to achieve the target wavelength.

### CROSS-REFERENCE TO RELATED APPLICATIONS

N/A.

### FIELD

The present disclosure outlines an advanced LED lighting system specifically engineered for dark sky compliance through precise wavelength control and real-time adjustments in response to temperature fluctuations.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for adaptive wavelength control in an LED lighting system. The method also includes emitting light from an LED at a specific wavelength. The method also includes detecting the specific wavelength using a photodetector. The method also includes analyzing the detected wavelength for deviations from a target wavelength of approximately 592 nanometers. The method also includes adjusting a current and a voltage supplied to the led based on the detected wavelength to achieve the target wavelength. Other embodiments of this aspect include corresponding computer systems, apparatus, and computer programs recorded on one or more computer storage devices, each configured to perform the actions of the methods.

Implementations may include one or more of the following features. The method where the adjustment of the current and voltage is continuously performed to maintain the light within the specified wavelength. The method further including actively monitoring a temperature to counteract shifts in the LED's emitted wavelength caused by temperature variations. The method may include storing optimal voltage and current settings in a memory for future reference and quick adjustment via a processor. The method further including a mesh network to coordinate light distribution patterns among multiple led lighting units. Light distribution patterns are adjustable through interchangeable lenses. The method may include using machine learning algorithms to analyze environmental factors and user-defined parameters for optimized light intensity distribution. The method may include adapting the light output based on real-time temperature data and preset values to maintain may include performance under varying environmental conditions. The method may include communicating with external service providers for enhanced functionalities, including machine learning-based heatmap generation. Implementations of the described techniques may include hardware, a method or process, or computer software on a computer-accessible medium.

One general aspect includes an. The advanced led lighting system also includes a controller programmed to emit light at a specific wavelength from an led, primarily focusing on amber led light. The system also includes a photodetector for detecting the wavelength of the emitted light. The system also includes a processor connected to the photodetector for analyzing the detected wavelength. The system also includes adjustable power supply connected to the led, where voltage and current can be adjusted by the processor to achieve the specific wavelength. Other embodiments of this aspect include corresponding computer systems, apparatus, and computer programs recorded on one or more computer storage devices, each configured to perform the actions of the methods.

Implementations may include one or more of the following features. The system where the processor is configured to continuously adjust the current and voltage supplied to the led based on the specific wavelength. The system may include temperature monitoring means to counteract wavelength shifts due to temperature variations. The system may include a memory for storing optimal voltage and current settings for the led to achieve the specified wavelength. The processor is configured to communicate with a mesh network for coordinating light distribution among multiple units. Light distribution patterns are adjustable through interchangeable lenses. The system may include a service provider that includes machine learning algorithms for analyzing environmental factors and user-defined parameters to optimize light intensity distribution. The processor is configured to adapt light output based on real-time temperature data and preset values for may include performance under varying environmental conditions. Implementations of the described techniques may include hardware, a method or process, or computer software on a computer-accessible medium.

One general aspect includes a method for adaptive wavelength control in an LED lighting system. The method also includes emitting light from an led at a specific wavelength, primarily focusing on amber led light. The method also includes detecting an emitted spectrum of the light to determine luminance from a surface. The method also includes detecting luminance deviations from a baseline luminance. The method also includes adjusting a current and a voltage supplied to the led based on the detected luminance deviations. Other embodiments of this aspect include corresponding computer systems, apparatus, and computer programs recorded on one or more computer storage devices, each configured to perform the actions of the methods.

Implementations may include one or more of the following features. The method may include: analyzing the emitting light for deviations from a target wavelength of 592+/−2 nanometers; and adjusting the current and voltage supplied to the led based on the detected wavelength to achieve the target wavelength. Implementations of the described techniques may include hardware, a method or process, or computer software on a computer-accessible medium.

### BRIEF DESCRIPTION OF THE DRAWINGS

Exemplary embodiments are illustrated by way of example and not limited by the figures of the accompanying drawings, in which references indicate similar elements.

FIG. 1 is an example architecture of the present disclosure.

FIG. 2 is a schematic diagram of an example LED assembly.

FIG. 3 is an example flow diagram of a method of the present disclosure.

FIG. 4 is another example flow diagram of a method of the present disclosure.

FIG. 5 is a schematic diagram of an example computer system that can be used to implement embodiments of the present disclosure.

### DETAILED DESCRIPTION OF EXAMPLE EMBODIMENTS

### Overview

In recent years, the issue of light pollution has become increasingly prominent. Light pollution refers to the excessive and intrusive artificial light that is spilling into the night sky, obscuring the natural darkness. This phenomenon is primarily caused by the widespread use of artificial lighting, including street lamps, building lights, and other sources of outdoor lighting that are not properly shielded or directed. As a result, the natural darkness of the night sky is diminished, making it difficult to observe stars and other celestial objects.

The impact of light pollution is significant and far-reaching. Not only does it affect astronomical observations by making it harder to see stars and other celestial bodies, but it also disrupts ecosystems and wildlife, as many species rely on natural patterns of light and dark for their survival. Furthermore, light pollution can have adverse effects on human health, contributing to sleep disorders and other issues related to the disruption of circadian rhythms.

Rayleigh scattering is a key optical phenomenon that occurs when white light passes through the Earth's atmosphere. This effect causes light to be dispersed and reflected in all directions. It is named after the British physicist Lord Rayleigh, who first described it in the late 19th century. Rayleigh scattering is primarily responsible for the blue color of the sky during the day, as it scatters shorter wavelengths of light (blue and violet) more efficiently than longer wavelengths (such as red and yellow).

The relevance of Rayleigh scattering to light pollution becomes evident particularly in the context of night sky glow. Due to its shorter wavelength, blue light is scattered more significantly than other colors in the visible spectrum. When artificial sources emit white light, which contains blue light, this blue component is scattered extensively in the night sky, contributing to what is known as light pollution and sky glow. This scattering effect reduces the visibility of stars and celestial bodies, contributing to the growing concern of light pollution in urban and suburban areas.

Traditional LED lighting systems, while efficient and long-lasting, often contribute significantly to light pollution. This pollution not only obscures the night sky, making it difficult for astronomers and stargazers to observe celestial objects, but also disrupts ecosystems and wildlife, particularly nocturnal animals. Additionally, excessive artificial light can have adverse effects on human health, such as disturbing sleep patterns. A major contributing factor to light pollution is non-dark sky compliant lighting, which emits light upwards or horizontally, rather than directing it downwards where it is needed.

Chromaticity refers to the quality of color regardless of its luminance, encompassing hue and saturation. In the context of LED lighting systems, particularly those focusing on adaptive wavelength control, chromaticity plays a pivotal role. This is because the chromatic properties of light emitted by LEDs significantly impact both the visual appearance of illuminated objects and the environmental effects of the lighting system.

Chromaticity is particularly crucial in dark sky-compliant LED lighting systems. The chromatic characteristics of the light emitted, such as its color temperature and spectral distribution, are key factors in determining the system's impact on nocturnal wildlife and its contribution to light pollution. For instance, light with a high blue content, commonly found in cooler color temperatures, is more likely to contribute to skyglow and disrupt wildlife, compared to warmer light with less blue content.

The careful control of chromaticity is important for ensuring the system's compliance with dark sky standards. By emitting light with a reduced blue spectrum and a focus on warmer color temperatures, the system minimizes its contribution to skyglow and reduces its disruptive impact on nocturnal ecosystems. This approach aligns with the growing awareness of the environmental impacts of artificial lighting and the need for more ecologically responsible lighting solutions.

The advanced LED lighting system described addresses these concerns by being specifically designed to be dark sky compliant. This compliance is achieved through several key features:

Directional Lighting: The system utilizes LED arrangements that focus light downwards, minimizing the amount of light that escapes upwards into the night sky. This directional lighting significantly reduces light pollution.

Amber LEDs: The choice of amber LEDs is crucial in this context. Amber light, with its specific wavelength range of approximately 590 to 620 nm, is less disruptive to nocturnal wildlife and is less likely to contribute to skyglow compared to LEDs with shorter wavelengths, like blue or white light.

Adjustable Intensity and Wavelength: The adjustable power supply and the precision control provided by the system's controller allow for the regulation of light intensity and wavelength. This means that the lighting can be optimized for various environmental conditions, ensuring that it is bright enough for safety and visibility, yet dim enough to minimize its impact on the night sky.

Real-Time Adjustments for Environmental Conditions: The incorporation of photodetectors and machine learning algorithms enables the system to adapt its lighting based on real-time environmental data. For instance, on nights with higher potential for light pollution (e.g., clearer skies), the system can automatically dim the lights or adjust the wavelength to further reduce its impact.

Mesh Network Capability: The mesh network functionality allows for coordinated light distribution across multiple units. This coordination ensures uniform lighting, preventing overly bright spots that can contribute to light pollution. Additionally, it enables the system to respond collectively to changes in environmental conditions, further enhancing its dark sky compliance.

In summary, this advanced LED lighting system presents a comprehensive solution to the problem of light pollution. By combining amber LEDs, directional lighting, and intelligent, adaptive controls, it ensures efficient lighting while being mindful of its impact on the night sky and the environment. This makes it an ideal choice for urban and rural areas alike, where the preservation of natural darkness is increasingly valued.

### Example Embodiments

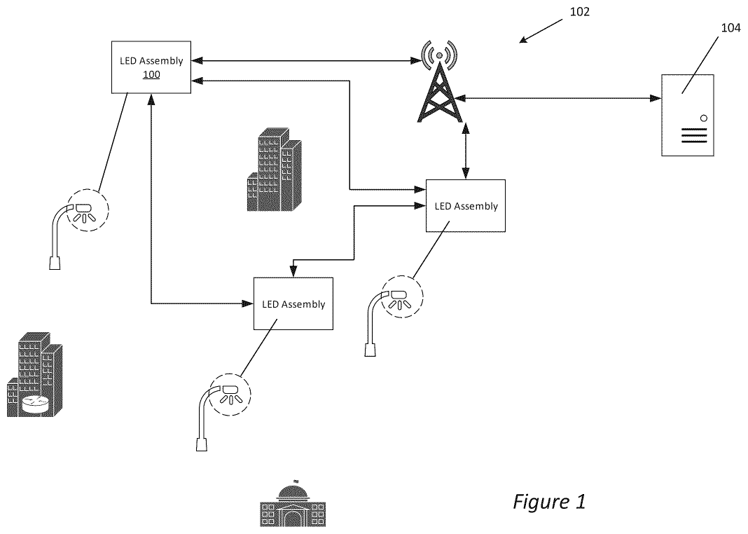

FIG. 1 illustrates a schematic diagram representing the architecture as disclosed in the present disclosure. This architecture is primarily composed of a network of LED assemblies, exemplified by LED assembly 100. These assemblies are strategically distributed across a designated area, typically urban environments like a city. Each LED assembly in this network is designed to efficiently illuminate the area while minimizing light pollution, a key feature for compliance with dark sky standards.

The advanced LED lighting system incorporates a sophisticated chromaticity control mechanism. This mechanism ensures that the light emitted not only adheres to the specified wavelengths but also possesses the desired chromatic characteristics. This is achieved through the precise tuning of the LED's spectral output, ensuring that the emitted light aligns with the target chromaticity coordinates.

The chromaticity control is facilitated by a combination of LED selection, optical filters, and electronic control systems. By selecting LEDs with specific spectral properties and employing filters that can modify these properties, the system can produce light with the desired chromatic characteristics. Additionally, the system's electronic control mechanisms allow for real-time adjustments to the chromaticity, responding to changes in environmental conditions or specific user requirements.

Furthermore, the system's chromaticity control contributes to its overall efficiency and effectiveness. By optimizing the color characteristics of the light, the system enhances visual comfort and safety for human users while simultaneously addressing environmental concerns. This dual focus on human-centric lighting and ecological responsibility represents a forward-thinking approach in the field of LED lighting technology.

The LED assemblies within this architecture are interconnected through a sophisticated communication network 102. This network enables seamless data exchange and coordination among the LED assemblies. The network could include any one or more private or public networks that can include wired or wireless communications (could include a cellular backhaul as an example). It facilitates the implementation of adaptive lighting control, wherein the intensity and direction of the LED lights can be adjusted in real-time. This adaptability is crucial for reducing unnecessary skyglow and glare, thereby adhering to dark sky compliance guidelines.

In certain configurations, the LED assemblies are also integrated with a service provider, denoted as service provider 104 in FIG. 1. This connection allows for external control and monitoring of the lighting system. The service provider 106 can implement algorithms for optimal light distribution, ensuring that the lighting is concentrated on the required areas while avoiding over-illumination of the sky. Such controlled illumination is essential for preserving the night sky's natural state and aligns with the objectives of dark sky initiatives.

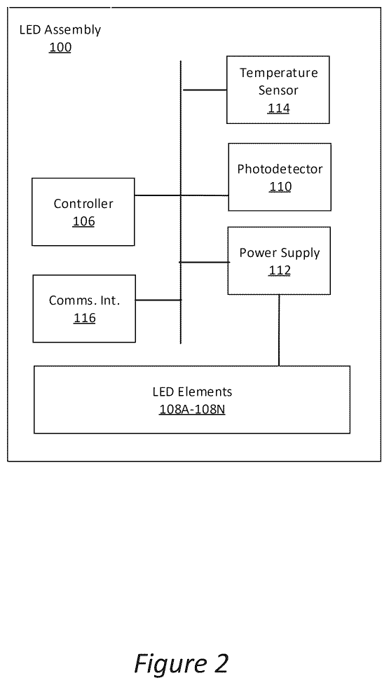

In FIG. 2, the LED assembly 100 architecture is centered around a controller 106. The controller 106 encompasses a processor core, memory, and customizable input/output peripherals. The controller 106 is configured to manage a variety of tasks, with a particular focus on emitting light at selectable wavelengths. The programming of the controller facilitates the emission of light in specific spectral ranges, such as the amber spectrum. This feature is particularly advantageous in applications where the sensitivity of amber light to temperature variations plays a role.

The lighting component of the system is primarily composed of LED elements 108A-108N. These LED elements, functioning as semiconductor light sources, activate upon the application of current. The design enables LEDs to emit light within a wavelength range approximately between 590 to 620 nm (in some instances 590+/−2 nm). Attributes such as energy efficiency, prolonged operational lifespan, and consistent light output characterize these LEDs. The specific wavelength properties of the amber LEDs make them highly suitable for scenarios where temperature sensitivity is a key factor, allowing for the provision of precise data.

Complementing the LEDs is a photodetector 110, a sensor configured to transform light into electrical signals that can be processed by the controller. This photodetector is sensitive to a spectrum of light wavelengths and demonstrates a rapid response to variations in light intensity. It plays a role in gauging the intensity of light emitted by the amber LEDs, which can be reflective of changes in environmental temperatures. The selection of this photodetector is predicated on its sensitivity and swift response time, attributes that are used for reliable monitoring and response functions.

An adjustable power supply 112 is included and tasked with delivering the requisite electrical power. This power supply is configurable, permitting fine-tuned control over the voltage and current supplied to the LEDs. Such adjustability is useful in ensuring that the LEDs emit light at specific wavelengths and intensities, a factor that is essential for consistent system performance, particularly in applications sensitive to temperature fluctuations.

The system's design is further augmented by the incorporation of mesh network capabilities, allowing interconnected communications with other LED assemblies. This feature facilitates communication and coordination among multiple units within the system. Such a network arrangement allows for diverse patterns of light distribution and enables the implementation of advanced features, such as machine learning algorithms for heatmap generation. Additionally, the mesh network capability extends to interfacing with external service providers, broadening the system's functionality.

In more detail, the processor can fine-tune various metrics to achieve optimal performance in an advanced LED lighting system. The key metrics that can be adjusted by the processor include current, flux, voltage, and color specifications. Each of these metrics plays a role in ensuring that the LED system meets its intended performance and compliance requirements.

The processor can adjust the Nominal Current (mA) supplied to the LEDs. By varying the current, it can control the intensity of light emitted by the LEDs. This is used to maintain the desired luminosity levels and for adapting to different environmental conditions, such as dimming the lights during periods of low ambient light to reduce light pollution.

The flux (lm), or the total amount of light emitted by the LED, is another metric. The processor can fine-tune the LED's output to ensure optimal flux levels are maintained. This involves balancing the need for sufficient brightness for visibility and safety with the need to minimize light pollution and energy consumption. Both typical and minimum flux levels can be regulated. The processor ensures that the flux remains within these ranges, optimizing for efficiency and compliance with dark sky standards.

Voltage regulation is used to maintain the LED's operational stability and longevity. The processor can adjust the voltage to match the requirements of the LED, ensuring it operates efficiently without being overdriven, which can lead to reduced lifespan or inconsistent performance.

Color specification is particularly important for dark sky compliance and minimizing ecological impact. The processor can adjust the wavelength of the LED light, in this case, focusing on the amber spectrum (approximately 590-620 nm and in some instances 590+/−2 nm). By fine-tuning the color coordinates in the color space, the processor ensures that the light emitted falls within the desired spectral range. This is essential for minimizing the impact on nocturnal wildlife and reducing skyglow.

In sum, the processor in an advanced LED lighting system can optimize various performance metrics. By adjusting current, flux, voltage, and color specifications, the processor ensures that the lighting system operates efficiently, complies with dark sky standards, and meets the specific needs of the environment in which it is deployed. This level of control and adaptability is essential for balancing human lighting needs with environmental considerations.

Machine learning algorithms are implemented (typically at a service provider level), enhancing the ability to intelligently analyze various environmental factors and user-defined parameters, like temperature ranges and preset illumination levels. This analytical capability allows the system to optimize light intensity in specific areas requiring enhanced illumination, thereby ensuring efficient and focused lighting solutions.

Considering the temperature sensitivity of amber LEDs, the system is equipped with mechanisms to actively monitor ambient temperature conditions, such as a temperature sensor 114. This ensures maintenance of the desired light wavelength. The system achieves this through a setup where the emitted light, detected by the photodetector, is processed by a controller linked to a dimming control mechanism on the power supply. This arrangement facilitates ongoing adjustments in current and voltage, aiming to achieve light emission at a specific wavelength, particularly around 592±2 nanometers. The system is designed to store the optimal voltage and current settings required to attain this wavelength in its memory, providing a reference for future adjustments and thereby enhancing the system's overall efficiency in maintaining desired light output characteristics.

Also, enhancing the LED array with a greater quantity of LED elements yields substantial improvements in thermal management. Specifically, augmenting the number of LED elements leads to a reduction in the power consumption necessary to attain a given luminance output, in comparison to configurations with fewer LED elements. For instance, a configuration with fifteen LED elements demands significantly lower power input to achieve a specified luminance level, as opposed to a configuration with only five LED elements, where higher power input is requisite to reach the same luminance.

Suppose an LED lighting system designed to operate with 30 LED elements. These LED elements are divided into three groups of ten each. The target is to achieve a uniform luminance of 600 lumens across the entire system while ensuring optimal power efficiency and minimal thermal stress.

The processor, being programmed to manage the power supply, would distribute the electrical current efficiently across all 30 LED elements. In contrast to driving fewer LEDs with higher power, this distribution results in lower power requirements per LED, enhancing overall system efficiency. The processor, using its connected adjustable power supply, dynamically adjusts voltage and current to maintain optimal conditions for each group of LEDs.

Given the importance of temperature in affecting LED performance, the processor utilizes temperature monitoring means (as mentioned earlier in the system features). If a temperature rise is detected that could impact the LED's wavelength or luminance, the controller responds by adjusting the current supplied to the LEDs, thus controlling the heat generation.

Utilizing input from environmental sensors or photodetectors, the processor can detect changes in ambient light or temperature. In response, it can adjust the intensity or wavelength of the light emitted by the LEDs to maintain consistent performance, as per pre-defined settings stored in its memory.

The processor also ensures that each LED element contributes to the overall target luminance of 600 lumens, adjusting individual LEDs as necessary. Furthermore, it regulates the chromaticity of the emitted light, ensuring that the color quality remains consistent, in line with the set chromaticity parameters.

In summary, the processor in this LED lighting system intelligently manages power distribution, temperature regulation, environmental responsiveness, network coordination, and luminance consistency to maintain efficient and effective operation of the 30 LED elements. This approach exemplifies an intelligent control mechanism, ensuring that the system meets its performance objectives while adhering to energy efficiency and environmental standards.

In scenarios where there is an elevation in ambient temperature, the advanced LED lighting system employs an adaptive response mechanism to maintain optimal performance and longevity of the LED elements. The processor, equipped with temperature monitoring capabilities, actively detects changes in the surrounding environmental temperature. Upon identifying an increase in ambient temperature, the processor initiates a series of adjustments to the LED operation. These adjustments include reducing the current supplied to the LEDs, as elevated temperatures can lead to increased thermal stress and potential degradation of the LED components. Concurrently, the processor may modify the light output, such as dimming the LEDs or altering the light distribution patterns, to reduce the thermal load. This dynamic adjustment not only helps in preserving the structural integrity and efficiency of the LED elements but also ensures consistent light quality and intensity. The system's ability to autonomously adapt to temperature variations exemplifies its advanced thermal management strategy, crucial for maintaining the reliability and longevity of the LED lighting system in varying environmental conditions.

Also, to effectively control the emission spectrum of amber LEDs and specifically filter out wavelengths in the 300-500 nm range, a specialized approach combining hardware configuration and software-based control is employed. The hardware component incorporates optical filters that are adept at absorbing or reflecting light within the 300-500 nm wavelength band. These filters are precisely integrated into the LED assembly, allowing only the desired amber spectral components (typically in the 590-620 nm range) to be emitted.

The LED system's processor can manage this spectral filtering. Equipped with advanced software algorithms, it continuously monitors the light output using integrated photodetectors, which are sensitive to the LED's spectral distribution. If emissions in the 300-500 nm range are detected, the controller promptly adjusts the LED's operational parameters. This involves modulating the electric current supplied to the LEDs, as varying the current can alter the LEDs' spectral output.

Furthermore, the processor dynamically regulates additional parameters like the LED drive current's duty cycle and the operational temperature of the LEDs. This real-time fine-tuning is essential to maintain spectral consistency, ensuring that the light output remains within the desired amber wavelength range while effectively excluding the 300-500 nm wavelengths. Through this control mechanism, the system not only achieves precise spectral output but also enhances the overall efficiency and longevity of the LED lighting system.

Also, to facilitate mesh communications, as well as any other communications needed, the LED assembly can include a communications interface 116 that allows the processor to transmit and/or receive data over the network.

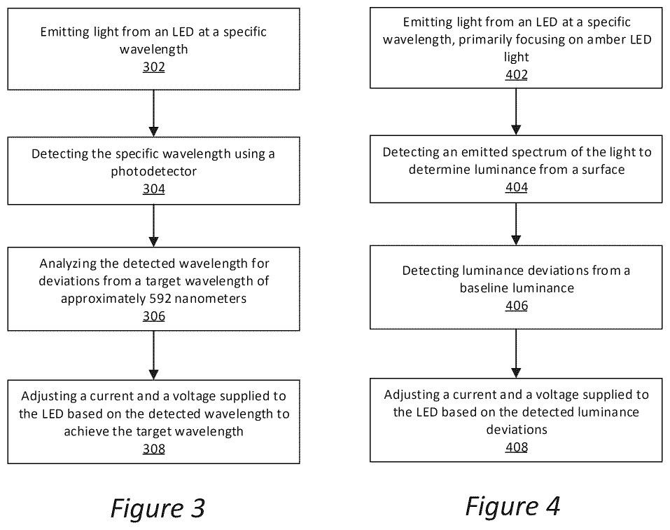

FIG. 3 is a flowchart of a method for adaptive wavelength control in an LED lighting system. The method can include a step 302 of emitting light from an LED at a specific wavelength. Next, the method includes a step 304 of detecting the specific wavelength using a photodetector.

In some embodiments, the method can include a step 306 of analyzing the detected wavelength for deviations from a target wavelength of approximately 592 nanometers.

The analysis of the detected wavelength for deviations from a target wavelength of approximately 592 nanometers begins with the data acquisition process, where the photodetector captures the light emitted by the LEDs. This light is then converted into an electrical signal, representing the specific wavelength characteristics of the emitted light. The electrical signal is processed by the system's controller or processor, which is equipped with specialized software algorithms. These algorithms analyze the signal to determine the actual wavelength of the emitted light.

Next, the processor compares the detected wavelength with the target wavelength of 592 nanometers. This comparison is crucial to ascertain any deviations, however minute, from the desired wavelength. The system employs sophisticated techniques, such as spectral analysis or wavelength comparison algorithms, to accurately determine these deviations. If the analysis reveals that the emitted light's wavelength deviates from the target, the processor initiates corrective measures. Thus, the method includes a step 308 of adjusting a current and a voltage supplied to the LED based on the detected wavelength to achieve the target wavelength.

As noted above, the adjustment of the current and voltage is continuously performed to maintain the light within the specified wavelength. In the context of maintaining the light within the specified wavelength, particularly around the target of 592 nanometers, the LED lighting system executes a continuous and dynamic adjustment of both current and voltage supplied to the LEDs. This process involves a series of steps. The system constantly monitors the output wavelength of the LEDs using photodetectors. These detectors provide real-time feedback on the light's spectral characteristics.

The data from the photodetectors is analyzed by the processor to determine if the current wavelength output aligns with the target of 592 nanometers. This analysis is not a one-time check but a continuous process to ensure ongoing compliance with the target wavelength. A processor uses specialized algorithms to calculate the precise adjustments needed in the current and voltage to correct any deviations from the target wavelength. These algorithms take into account factors like LED characteristics, temperature fluctuations, and aging effects, which can impact the LED's wavelength output.

Based on the analysis, the system dynamically modulates the current and voltage supplied to the LEDs. Increasing or decreasing the current can shift the wavelength output of the LEDs. Similarly, adjusting the voltage can affect the intensity and efficiency of the light output, which in turn can influence the wavelength. The system employs a feedback loop mechanism. After adjusting the current and voltage, the system re-monitors the wavelength output. If further deviations are detected, additional adjustments are made. This loop continues until the output stabilizes at the target wavelength.

In systems with multiple LEDs, these adjustments are not just made globally but also individually for each LED or LED group, ensuring uniform wavelength output across the entire system. External factors like ambient temperature changes can affect LED performance. The system compensates for these factors, adjusting current and voltage accordingly to maintain the wavelength within the narrow confines of the specified target. Through this detailed and adaptive process, the LED lighting system ensures that the light emitted consistently matches the specified wavelength, enhancing both the efficiency and the efficacy of the lighting solution.

In some embodiments, the method can include actively monitoring a temperature to counteract shifts in the LED's emitted wavelength caused by temperature variations. Actively monitoring temperature to counteract shifts in the LED's emitted wavelength due to temperature variations involves a comprehensive process.

The system can be equipped with temperature sensors strategically placed near the LED elements. These sensors continuously measure the ambient temperature and the temperature of the LED units themselves. Since the wavelength of light emitted by LEDs can shift with temperature changes, precise monitoring is crucial.

The temperature data collected by the sensors is relayed to the system's processor in real-time. This processor, equipped with advanced algorithms, analyzes the data to detect any significant temperature changes that might affect the LED's performance and wavelength emission.

The system's software has a built-in understanding of how temperature variations affect the specific types of LEDs in use. For example, an increase in temperature might lead to a shift in the LED's emitted wavelength towards the longer end of the spectrum.

Upon detecting a temperature change that could potentially alter the LED's emitted wavelength, the processor immediately initiates a response. This response involves adjusting operational parameters of the LED, such as current and voltage. To counteract the wavelength shift caused by temperature changes, the system dynamically adjusts the current and voltage supplied to the LEDs. Increasing or decreasing the current can help in shifting the wavelength back towards the desired target. The system makes these adjustments while also ensuring that the LEDs are operating within safe and efficient power ranges.

The system operates a continuous feedback loop where the effect of the adjustments on the LED's wavelength is monitored. If the wavelength is still deviating from the target due to ongoing temperature fluctuations, further adjustments are made. The goal of this active monitoring and response system is to maintain the optimal performance of the LEDs, ensuring that the light emitted remains consistent and true to the desired specifications, despite environmental temperature changes. Through this process, the system effectively mitigates the impact of temperature variations on the LED's emitted wavelength, maintaining consistent light quality and color accuracy.

In some instances, the method includes storing optimal voltage and current settings in a memory for future reference and quick adjustment via a processor. The process of storing optimal voltage and current settings in a memory for future reference and quick adjustment via a processor encompasses several steps.

Initially, the system goes through a calibration phase where it identifies the optimal current and voltage settings for each LED or group of LEDs. These settings are determined based on achieving the desired luminance and wavelength while maintaining energy efficiency and minimizing thermal stress. Once the optimal settings are identified, they are stored in the system's memory. This memory is integrated with the processor, enabling quick access and retrieval of the data. The stored settings act as a reference point or a ‘preset’ that can be quickly reverted to when needed.

As the LED lighting system operates, it may encounter varying environmental conditions or internal changes like aging of the LEDs. The processor continually makes adjustments to the current and voltage to maintain optimal performance. These adjustments, based on real-time data and feedback, are compared against the stored optimal settings.

If consistent deviations from the stored settings are required for optimal performance, the processor updates these settings in the memory. This update process may be governed by a machine learning algorithm that learns from the ongoing operational data, ensuring that the stored settings are always aligned with the most efficient and effective operation of the LEDs. In instances where rapid changes in operating conditions occur (such as sudden temperature spikes or drops), the processor can quickly access the stored optimal settings and make immediate adjustments. This rapid response capability is crucial for maintaining the quality and consistency of the light output.

For systems with multiple LEDs or LED arrays, the memory stores individual optimal settings for each unit or group. This ensures uniformity in light output across the entire system, despite variations in individual LED characteristics or positions. The processor not only responds reactively to changes but can also make predictive adjustments based on historical data and patterns stored in the memory. This proactive management helps in maintaining a high degree of stability and reliability in the lighting system.

In summary, the storage of optimal voltage and current settings in memory, coupled with the processor's capability for quick adjustment, ensures that the LED lighting system operates at peak efficiency and effectiveness, adapting swiftly to both predictable and unforeseen changes in operating conditions.

The method can include a mesh network to coordinate light distribution patterns among multiple LED lighting units. Coordinating light distribution patterns among multiple LED lighting units using a mesh network involves a networked system.

In an example system, each LED lighting unit is equipped with networking capabilities, allowing them to communicate with each other. These units form a mesh network, a type of network where each node (LED unit) is interconnected with multiple others. This network structure enables efficient data transmission and robust connectivity among all the units.

Unlike traditional centralized control systems, a mesh network distributes intelligence across all LED units. Each unit can make certain decisions independently, such as adjusting its brightness or color based on pre-set conditions or environmental inputs. While individual units have some autonomy, there is also a central controller or a set of controllers that oversee the entire mesh network. This controller coordinates the overall light distribution patterns, ensuring uniformity and harmony across all units.

The LED units continuously share data regarding their performance and environmental conditions with each other. This data includes light intensity, color, temperature readings, and operational status. Using this information, the units can synchronize their lighting output, creating a cohesive and adaptive lighting environment.

The mesh network enables the LED system to respond collectively to environmental changes. For instance, if one part of the networked area becomes darker due to cloud cover, the units in that area can autonomously increase brightness, while informing adjacent units to adjust their light output for a balanced distribution. The mesh network's structure allows for easy scalability. New LED units can be added to the network without significant reconfiguration. The network also allows for flexibility in light distribution patterns, making it suitable for various applications, from street lighting to architectural lighting.

The mesh network contributes to energy efficiency by enabling LED units to operate optimally based on collective data. It also provides fault tolerance; if one unit fails or becomes disconnected, the network reconfigures itself to maintain consistent lighting. In essence, using a mesh network to coordinate light distribution among multiple LED lighting units enables a dynamic, responsive, and efficient lighting system. This system can adapt to changing conditions and user requirements, offering a sophisticated solution for modern lighting needs.

In various embodiments, the method can include using machine learning algorithms to analyze environmental factors and user-defined parameters for optimized light intensity distribution.

The utilization of machine learning algorithms to analyze environmental factors and user-defined parameters for optimized light intensity distribution in an LED lighting system involves an intelligent process. The system continuously collects a vast array of environmental data, such as ambient light levels, temperature, weather conditions, and even time-of-day information. User-defined parameters, like desired brightness levels or specific lighting schedules, are also gathered. Machine learning algorithms analyze this data to understand patterns and correlations.

The algorithms are designed to learn from the collected data, identifying how different environmental factors affect the optimal light intensity distribution. For instance, the system might learn that certain weather conditions require adjustments in lighting intensity for optimal visibility and energy efficiency.

Using the insights gained from historical data, the machine learning algorithms create predictive models. These models forecast future lighting needs based on anticipated environmental changes and user preferences. This predictive capability allows the system to proactively adjust lighting before changes in environmental conditions occur.

The system uses the insights derived from the machine learning algorithms to dynamically adjust the light intensity of each LED unit. The adjustments are based on a combination of current environmental conditions and the predictive models, ensuring that the lighting is always optimized for the present and near-future conditions.

User-defined parameters are integrated into the machine learning models. This integration ensures that the system's lighting adjustments are not only responsive to environmental changes but also aligned with user preferences and requirements. The system includes a feedback mechanism where the performance of the lighting adjustments is monitored and analyzed. This feedback is used to further train and refine the machine learning models, ensuring continuous improvement in light distribution optimization.

The primary goal of using machine learning algorithms in this context is to balance energy efficiency with user comfort and safety. The system optimizes light intensity to reduce energy consumption while ensuring that lighting conditions are always comfortable and appropriate for the environment and user needs. In summary, the use of machine learning algorithms for analyzing environmental factors and user-defined parameters allows for a highly adaptive, efficient, and user-centric approach to light intensity distribution in LED lighting systems. This approach not only enhances the functionality and responsiveness of the lighting system but also contributes to its sustainability and user satisfaction.

The method can also include adapting the light output based on real-time temperature data and preset values to maintain consistent performance under varying environmental conditions.

Adapting the light output of an LED system based on real-time temperature data and preset values to maintain consistent performance under varying environmental conditions involves a highly responsive and intelligent process. The system is equipped with sensors that continuously monitor the ambient temperature. These sensors provide real-time temperature data, which is crucial for adapting the light output, as temperature variations can significantly impact LED performance, including luminosity and color temperature.

Alongside real-time data, the system also incorporates preset values. These values are predefined parameters that dictate the desired light output under specific temperature conditions. These presets are based on optimal performance standards and user preferences. The processor within the LED system constantly compares the real-time temperature data against these preset values. If the processor detects a discrepancy due to a change in temperature, it initiates an adjustment protocol. This protocol involves altering the current and voltage supplied to the LEDs, thereby adjusting the intensity and, in some cases, the color spectrum of the light output.

The system's ability to respond in real-time to temperature changes enables it to proactively adjust the light output before any noticeable impact on performance occurs. This ensures that the lighting remains consistent and efficient, regardless of environmental fluctuations. A feedback loop mechanism is integral to this process. After making adjustments, the system reassesses the lighting to ensure it aligns with the desired parameters. If further fine-tuning is necessary, additional adjustments are made, creating a cycle of continuous improvement.

By adapting the light output based on temperature, the system not only maintains consistent lighting performance but also enhances energy efficiency and prolongs the lifespan of the LED units. Excessive heat can degrade LEDs over time, so maintaining an optimal temperature range is crucial.

In environments where lighting is critical for safety and comfort, such as in outdoor public spaces or work areas, this adaptive feature ensures that the light remains stable and reliable, enhancing the overall user experience and safety. In essence, adapting the light output based on real-time temperature data and preset values is a sophisticated process that ensures the LED lighting system remains efficient, reliable, and consistent, even as environmental conditions change. This adaptability is key to delivering high-quality lighting that meets both user needs and energy efficiency standards.

FIG. 4 is a flowchart of another method for adaptive wavelength control in an LED lighting system. The methods outlined in FIG. 4 and FIG. 3 for adaptive wavelength control in an LED lighting system, while similar in their overarching goal of adjusting LED output, differ significantly in their approach and focus.

The method of FIG. 4 centers on the adaptation of light based on luminance feedback from a surface. It involves emitting light at a specific wavelength, detecting the spectrum of this light to determine the luminance reflected from a surface, and then detecting any deviations from a baseline luminance. This approach is particularly responsive to the environment in which the LED is operating, as it adjusts the current and voltage supplied to the LED in response to changes in the reflected light's luminance. This method is highly dynamic, emphasizing real-world interaction where the lighting conditions may vary due to external factors like surface reflectivity and ambient light.

In some instances, the method includes a step 402 of emitting light from an LED at a specific wavelength, primarily focusing on amber LED light. Next, the method can include a step 404 of detecting an emitted spectrum of the light to determine luminance from a surface. In some instances, the method includes a step 406 of detecting luminance deviations from a baseline luminance. In some instances, the method includes a step 408 of adjusting a current and a voltage supplied to the LED based on the detected luminance deviations. In some instances, the LED can be further controlled by analyzing the emitting light for deviations from a target wavelength of 592±2 nanometers and adjusting the current and voltage supplied to the LED based on the detected wavelength to achieve the target wavelength.

### Machine Learning

To configure a machine learning algorithm for a lighting system aimed at dark sky compliance, a process is executed for gathering and processing a range of environmental and sensor data. This includes collecting local light pollution levels, astronomical conditions like moon phases and cloud cover, weather conditions, and data from sensors measuring upward light emissions, ambient light levels, and human activity. This data needs to be cleaned and preprocessed to ensure consistency and accuracy for the machine learning model.

In terms of the machine learning model configuration, a time series forecasting model or a regression model, such as an LSTM network, would be appropriate. These models are adept at handling time-series data, which is crucial for predicting lighting needs based on changing environmental factors. Feature engineering is a critical step in this process, where relevant features like time, date, weather conditions, and sensor readings are selected for the model. The model's hyperparameters, including learning rate, number of layers, and neurons per layer, must be carefully tuned to avoid overfitting or underfitting.

The training of the model involves using a comprehensive historical dataset that reflects a wide range of environmental conditions. The model's performance should be evaluated using cross-validation techniques to ensure it generalizes well across different data subsets. It's also important to have a real-time feedback loop where the model is periodically updated with new data to refine its predictions.

For the implementation, the system must define thresholds for light intensity adjustments based on dark sky compliance standards. The model's output is used to adjust the lighting in real time, ensuring the light emission stays within these thresholds. For example, on clear, moonlit nights, the model might predict lower light requirements and accordingly dim the lights to reduce skyglow. Continuous monitoring of the system's performance against dark sky compliance metrics is essential, with adjustments made to the model as needed. Additionally, having a user interface for manual overrides can provide flexibility for unforeseen circumstances or specific local events.

This approach ensures that the machine learning algorithm is not only configured to adhere to dark sky compliance standards but is also adaptable to a variety of environmental conditions, balancing automated decision-making with the need for occasional human intervention.

### Example Use Cases

During winter, snow accumulation on roads can pose significant challenges for municipal services. Efficient snow removal is crucial for public safety and uninterrupted transit. However, identifying areas where snow has accumulated and not been plowed can be challenging, especially during ongoing snowfall or at night.

The advanced LED lighting system, with its adaptive wavelength control and network integration, offers a novel solution. This system includes amber LEDs that emit light at specific wavelengths (around 592 nm), photodetectors for detecting emitted light, and a processor that analyzes the detected light.

An LED assembly can detect light and transmit data pertaining thereto to a service provider over a network. The service provider can detect changes in surface luminance. Freshly fallen snow reflects more light than a plowed surface. By emitting light at a specific wavelength and analyzing the reflected light's intensity and spectrum, the system can infer the presence of snow on surfaces. The LED lighting system is connected to a network, allowing it to communicate with external service providers. This integration enables the system to send real-time data about snow accumulation to municipal snow removal services.

With integrated machine learning algorithms, the system can learn and improve its detection capabilities over time. It can distinguish between different types of surfaces and snow conditions, improving the accuracy of its snow accumulation assessments. The mesh network capability allows for coordinated monitoring across multiple LED units. This coordination enables the system to map snow accumulation across a broader area, identifying which streets or sections of a road have not been plowed.

Using this LED lighting system, municipalities can respond more efficiently to snowfall. They can prioritize snow removal efforts based on real-time data, ensuring major roads and critical areas are cleared first. This approach not only enhances public safety but also optimizes the use of resources, such as snowplows and salt spreaders.

In another use case, in urban areas, monitoring and managing traffic flow is crucial for reducing congestion and enhancing road safety. Traditional methods of traffic monitoring often rely on cameras or embedded road sensors, which can be costly to install and maintain. The advanced LED lighting system with adaptive wavelength control and network integration can be utilized as a novel approach for traffic monitoring and management.

The system can analyze changes in the luminance on the road surface to infer traffic flow patterns. Moving vehicles disrupt the light pattern on the road, creating a distinct luminance signature that can be detected by the system. By continuously monitoring road luminance, the system can provide real-time data on traffic density and flow patterns. This information can be relayed to traffic management centers to adjust traffic signals, optimize flow, and reduce congestion.

In the event of an accident or a sudden stop in traffic, the system can quickly detect these changes in luminance patterns and alert emergency services and traffic controllers, enabling a faster response to incidents. The system can be particularly effective in monitoring crosswalks. The change in luminance caused by pedestrians crossing the street can be detected, allowing for real-time alerts to nearby drivers or automatic activation of warning lights to enhance pedestrian safety.

The traffic data collected can be shared with navigation service providers to offer real-time traffic updates to drivers, helping them avoid congested routes. With integrated machine learning capabilities, the system can learn and recognize different traffic patterns, adapting its analysis and improving its accuracy over time.

Utilizing the advanced LED lighting system for traffic flow monitoring offers a cost-effective, scalable, and versatile solution for urban traffic management. It enhances road safety, reduces congestion, and provides valuable data for city planners and traffic controllers. This approach also minimizes the need for additional infrastructure, such as road sensors or cameras, leveraging existing street lighting for multiple purposes.

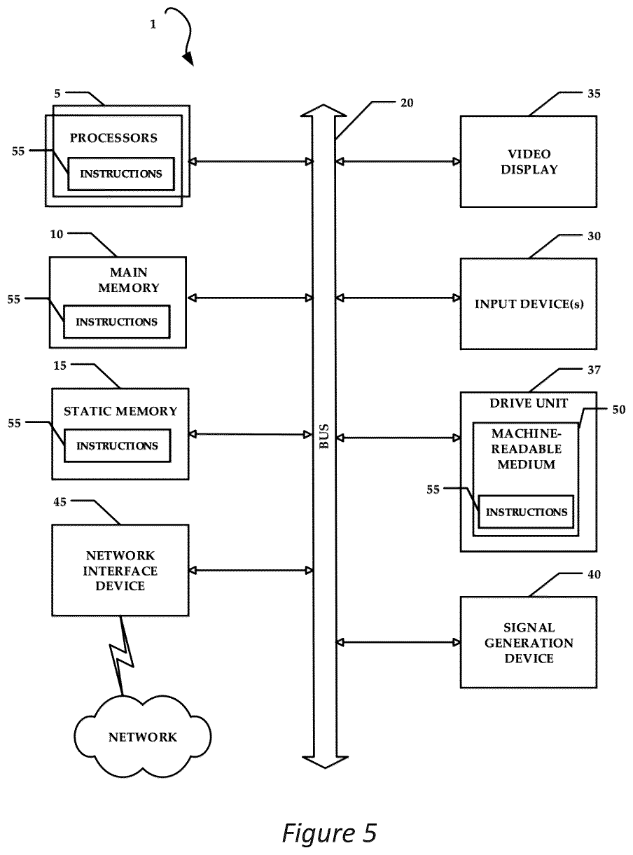

FIG. 5 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A method for adaptive wavelength control in an LED lighting system, comprising:
emitting light from an LED at a specific wavelength;
detecting the specific wavelength using a photodetector;
analyzing the detected wavelength for deviations from a target wavelength of approximately 592 nanometers; and
adjusting a current and a voltage supplied to the LED based on the detected wavelength to achieve the target wavelength.

2. The method of claim 1, wherein the adjustment of the current and voltage is continuously performed to maintain the light within the specified wavelength.

3. The method of claim 1, further including actively monitoring a temperature to counteract shifts in the LED's emitted wavelength caused by temperature variations. LD 90 lumens per watt, more LEDs.

4. The method of claim 1, further comprising storing optimal voltage and current settings in a memory for future reference and quick adjustment via a processor.

5. The method of claim 1, further including a mesh network to coordinate light distribution patterns among multiple LED lighting units.

6. The method of claim 5, wherein light distribution patterns are adjustable through interchangeable lenses.

7. The method of claim 1, further comprising using machine learning algorithms to analyze environmental factors and user-defined parameters for optimized light intensity distribution.

8. The method of claim 1, further comprising adapting the light output based on real-time temperature data and preset values to maintain consistent performance under varying environmental conditions.

9. The method of claim 1, further comprising communicating with external service providers for enhanced functionalities, including machine learning-based heatmap generation.

10. An advanced LED lighting system comprising:
a controller programmed to emit light at a specific wavelength from an LED, primarily focusing on amber LED light;
a photodetector for detecting the wavelength of the emitted light; and
a processor connected to the photodetector for analyzing the detected wavelength; and
adjustable power supply connected to the LED, where voltage and current can be adjusted by the processor to achieve the specific wavelength.

11. The system of claim 10, wherein the processor is configured to continuously adjust the current and voltage supplied to the LED based on the specific wavelength.

12. The system of claim 10, further comprising temperature monitoring means to counteract wavelength shifts due to temperature variations.

13. The system of claim 10, further comprising a memory for storing optimal voltage and current settings for the LED to achieve the specified wavelength.

14. The system of claim 10, wherein the processor is configured to communicate with a mesh network for coordinating light distribution among multiple units.

15. The system of claim 14, wherein light distribution patterns are adjustable through interchangeable lenses.

16. The system of claim 10, further comprising a service provider that includes machine learning algorithms for analyzing environmental factors and user-defined parameters to optimize light intensity distribution.

17. The system of claim 10, wherein the processor is configured to adapt light output based on real-time temperature data and preset values for consistent performance under varying environmental conditions.

18. A method for adaptive wavelength control in an LED lighting system, comprising:
emitting light from an LED at a specific wavelength, primarily focusing on amber LED light;
detecting an emitted spectrum of the light to determine luminance from a surface;
detecting luminance deviations from a baseline luminance; and
adjusting a current and a voltage supplied to the LED based on the detected luminance deviations.

19. The method of claim 18, further comprising:
analyzing the emitting light for deviations from a target wavelength of 592±2 nanometers; and
adjusting the current and voltage supplied to the LED based on the detected wavelength to achieve the target wavelength.
